(19) United States
(12) Patent Application Publication
(10) Pub. No.: US 2014/0293184 A1
(43) Pub. Date: Oct. 2, 2014

(54) DISPLAY DEVICE

(71) Applicant: Funai Electric Co., Ltd., Osaka (JP)

(72) Inventor: Tomokazu SUGAMURA, Daito-shi (JP)

(73) Assignee: Funai Electric Co., Ltd., Osaka (JP)

(21) Appl. No.: 14/225,752

(22) Filed: Mar. 26, 2014

(30) Foreign Application Priority Data
Apr. 2, 2013 (JP) 2013-077160

(51) Int. Cl. G02F 1/1333

(52) U.S. Cl. CPC G02F 1/133308
USPC 349/58

(57) ABSTRACT

A display device includes a substrate holding unit that holds a PCB connected to a specified circuit with the use of a COF. The substrate holding unit includes a plate and a restricting member that restricts movement of the PCB in a Z direction which is perpendicular or substantially perpendicular to a plane of the plate, and a leaf spring provided in a portion of the plate. The leaf spring includes a leaf spring main body which includes, on a side of the surface on which the PCB is held, a protrusion that contacts the PCB and presses the PCB against the restricting member and can swing in the first direction, and an opening that is provided in an area of the plate that surrounds the leaf spring main body excluding a support area which causes the leaf spring main body to be supported on the substrate holding unit.

### BACKGROUND OF THE INVENTION

1. Field of the Invention

The present invention relates to a display device and particularly to a display device including a module that holds a substrate.

2. Description of the Related Art

A liquid crystal display which is one example of a display device is configured to include, for example, a liquid crystal panel, a light source such as light-emitting diodes (LEDs), a control circuit, a power supply circuit, a printed circuit board (PCB), a chip on film (COF), a case that houses these members, and so forth.

The control circuit is a circuit that controls various circuits and mechanisms of the liquid crystal panel.

The power supply circuit is a circuit that converts AC power from an external power source into DC power to be used by a drive circuit and the liquid crystal panel and supplies the DC power to the drive circuit and the liquid crystal panel.

The COF includes an IC (one example of a drive circuit) and uses signals from the control circuit to generate drive signals that drive the liquid crystal panel. The COF is connected between the liquid crystal panel and the PCB.

The PCB is a substrate that outputs signals from the control circuit to the IC mounted on the COF.

FIG. 8 is an external view showing the external appearance of a liquid crystal panel as seen from the back surface. FIG. 9 is a sectional view of the line C-C portion in FIG. 8. FIG. 10 is a diagram showing the configuration that holds the PCB. Note that in FIGS. 8 and 10, the horizontal direction of the liquid crystal panel (not shown) of a liquid crystal display 100 is taken as the X direction, the vertical direction is taken as the Y direction, and the thickness direction is taken as the Z direction.

The case of the liquid crystal display 100 includes a rear frame 101 and a cover part 102 provided on the upper portion of the rear frame 101 as shown in FIG. 8. As shown in FIGS. 9 and 10, the cover part 102 includes gaskets 103 that press the PCB 20 onto a substrate holding part 140 and secures it in a state in which the cover part 102 is attached to the rear frame 101. Cushion members (such as packing) are provided on the surfaces of the gaskets 103 that contact the PCB 20.

Furthermore, the PCB 20 and the substrate holding part 140 that hold the PCB 20 are disposed on the interior of the case as shown in FIG. 9. As shown in FIG. 10, the substrate holding part 140 is configured with the use of a plate-form member 141 and includes a clasp part 142 that restricts the movement of the PCB 20 in the Z direction and in the direction opposite to the Y direction and a clasp part 143 that restricts the movement of the PCB 20 in the Y direction.

As was described above, the PCB 20 is secured to the substrate holding part 140 by the gaskets 103 in the conventional liquid crystal display 100.

With such a display device, the case may vibrate during audio output or the like.

If the PCB is firmly secured when this happens, there are cases in which problems occur, such as the connecting portion between the COF and the PCB being damaged or removed.

### SUMMARY OF THE INVENTION

Preferred embodiments of the present invention provide a display device including a substrate holding unit that significantly reduces or prevents problems caused by vibration.

A display device according to a preferred embodiment of the present invention includes a substrate holding unit which holds a substrate that is connected to a specified circuit using a cable, wherein the substrate holding unit includes a plate and a restricting member that restricts movement of the substrate in a first direction perpendicular or substantially perpendicular to the plane of the plate and a leaf spring provided in a portion of the plate, and the leaf spring includes a leaf spring main body which includes, on a side of the surface on which the substrate is held, a protrusion that contacts the substrate and presses the substrate against the restricting member and which can swing in the first direction and an opening that is provided in an area of the plate that surrounds the leaf spring main body excluding a support area which causes the leaf spring main body to be supported on the substrate holding unit.

With the display device having the configuration described above, the substrate is pressed against the restricting member and secured by the elastic force of the leaf spring. Having such a configuration enables the substrate to move slightly if a certain amount of force or more is applied to the leaf spring.

Note that the conventional liquid crystal display 100 shown in FIGS. 8 to 10 uses gaskets 103 to press the PCB 20 against the substrate holding unit 140 and to secure it, so even when the case vibrates, the PCB 20 which is one example of a substrate that cannot move. In this case, a connection between the PCB and the COF may be damaged or removed in some instances.

On the other hand, with the display device having the above-described configuration according to a preferred embodiment of the present invention, because the substrate can move slightly when a certain amount of force or more is applied to the leaf spring, it is possible to reduce the damage or removal of the connection between the PCB and the COF even when the display device vibrates. Consequently, product yield is greatly improved.

For example, the protrusion may preferably have a conical or substantially conical shape such that a sectional area of a cross section parallel or substantially parallel to the plane of the plate becomes smaller with increasing distance away from the plane of the plate.

Moreover, the protrusion may preferably have a hemispherical or substantially hemispherical shape.

In addition, the protrusion may have a configuration that makes point contact with the substrate.

Furthermore, the thickness of the leaf spring main body may be smaller than the thickness of the portion of the plate excluding the leaf spring main body.

Moreover, a second restricting member may further be provided to restrict the movement of the substrate in a second direction perpendicular or substantially perpendicular to the first direction.

In addition, the second restricting member may include a second plate that extends in the first direction from the surface of the plate, and the first restricting member may be configured include a first plate that extends in a direction perpendicular or substantially perpendicular to the first direction from the tip end of the second restricting member.

Furthermore, the plate may be made of resin.

Moreover, the opening may be arranged to surround the leaf spring main body on at least three sides thereof.

In addition, the support area may have a rectangular or substantially rectangular first region, a first connecting region which is provided on a long side of the first region at one of the tip end portions thereof and which connects with the plate, and a second connecting region which is provided on a side facing the long side at the other tip end portion of the first region and which connects with the leaf spring main body.

With various preferred embodiments of the present invention, it is possible to provide a display device including a substrate holding unit that significantly reduces or prevents problems caused by vibration.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external view showing the external appearance of a liquid crystal display according to a preferred embodiment of the present invention as seen from a back surface thereof.

FIG. 2 is a sectional view of the line A-A portion in FIG. 1.

FIG. 3 is a perspective view showing one example of a configuration of a substrate holding unit according to a preferred embodiment of the present invention.

FIG. 4 is a model diagram of a substrate holding unit according to a preferred embodiment of the present invention as seen from a side to which a substrate is attached.

FIG. 5 is a sectional view showing one example of the configuration of a substrate holding unit according to a preferred embodiment of the present invention.

FIG. 6 is a diagram showing an example of a configuration of a leaf spring according to a preferred embodiment of the present invention.

FIG. 7 is a diagram showing another example of a configuration of a leaf spring according to a preferred embodiment of the present invention.

FIG. 8 is an external view showing an external appearance of a conventional liquid crystal display as seen from a back surface thereof.

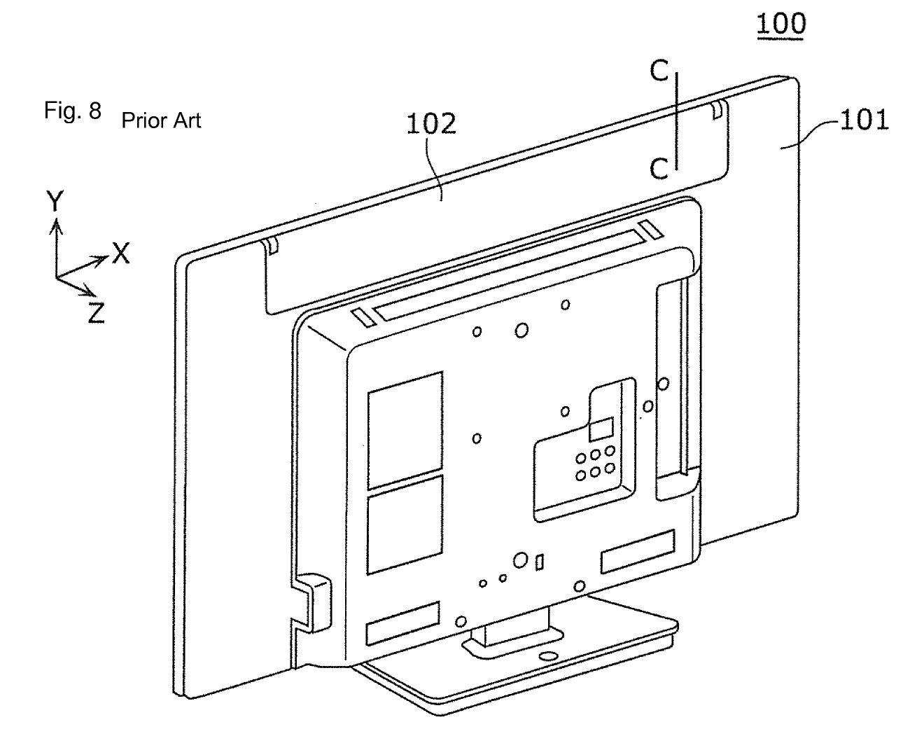

FIG. 9 is a sectional view of the line C-C portion in FIG. 8.

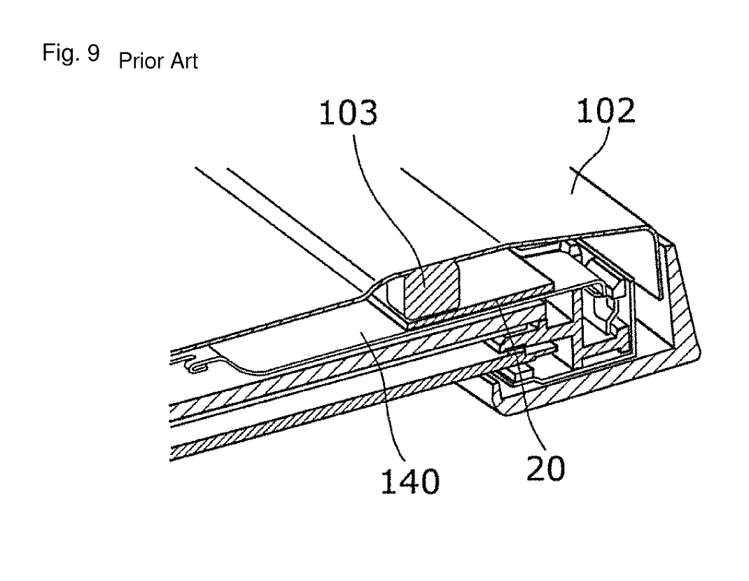

FIG. 10 is a conventional diagram showing one example of a configuration of a substrate holding unit.

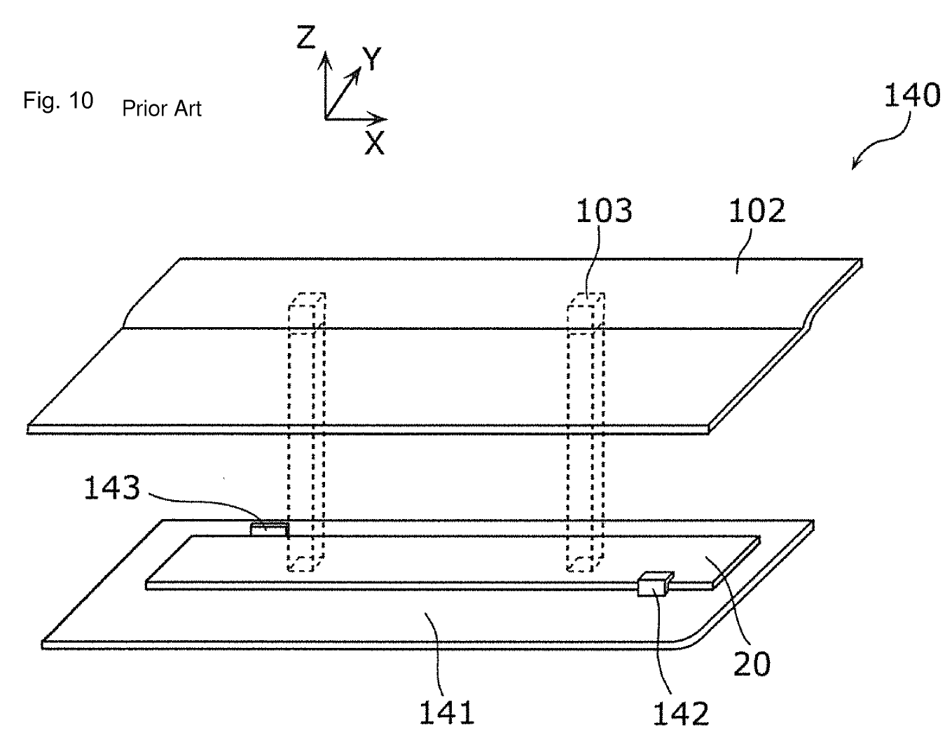

### DETAILED DESCRIPTION OF THE PREFERRED EMBODIMENTS

Preferred embodiments of the present invention will be described in detail below using the drawings. Note that each of the figures does not necessarily depict the individual dimensions, dimensional ratios, or the like in a precise manner.

Furthermore, each of the preferred embodiments to be described below represents a preferred specific example of the present invention. The numerical values, shapes, materials, constituent elements, the disposed positions and connection modes of the constituent elements, steps, the sequence of steps, and so forth indicated in the preferred embodiments described below are just examples and do not limit the present invention. The present invention is specified by the scope of the claims. Therefore, those constituent elements not recited in the independent claims that are among the constituent elements included in the preferred embodiments below are not necessarily required in any of the preferred embodiments of the present invention but are described as constituting a more preferable form.

### Preferred Embodiment 1

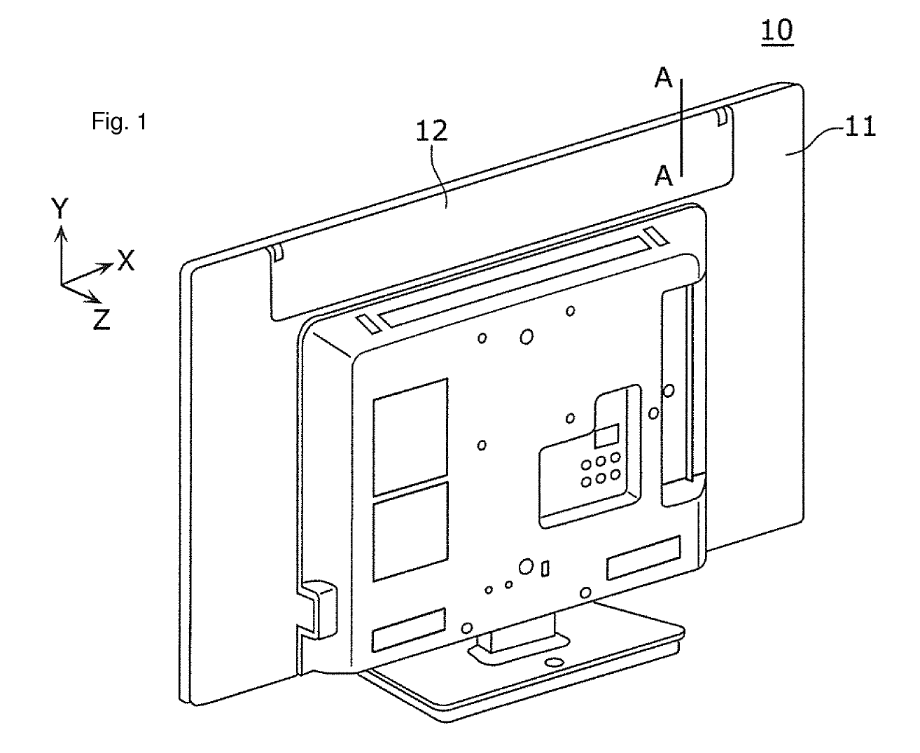

A display device according to Preferred Embodiment 1 will be described based on FIGS. 1 to 4.

The display device of the present preferred embodiment includes a substrate holding unit that holds a substrate to be connected to a specified circuit using a flexible cable. In the present preferred embodiment, a case of the display device preferably in the form of a liquid crystal display will be described as an example. The specified circuit is, for example, the control circuit of the liquid crystal display.

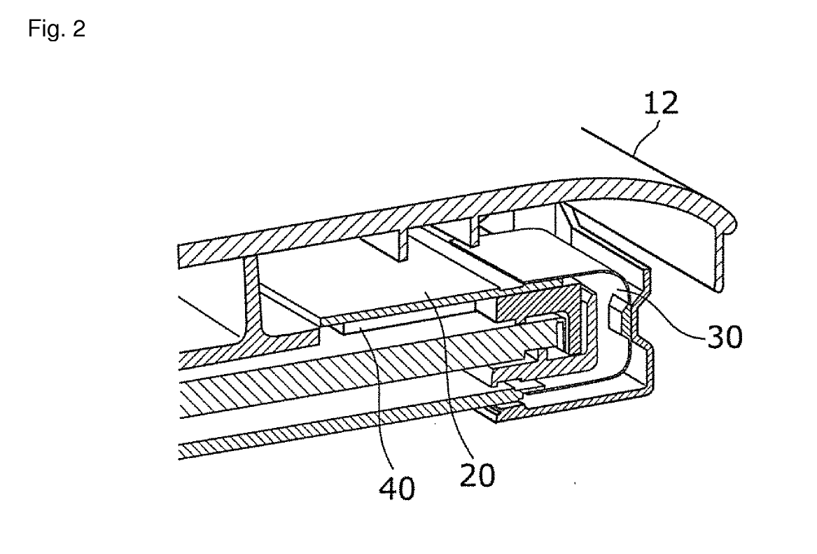

The configuration of the liquid crystal display of the present preferred embodiment will be described based on FIGS. 1 and 2. FIG. 1 is an external view showing the external appearance of the liquid crystal display 10 as seen from the back surface. FIG. 2 is a sectional view along line A-A in FIG. 1.

Note that in the following description, the X direction in each figure indicates the horizontal direction of the liquid crystal panel constituting the liquid crystal display (the direction from the left toward the right as seen from the side of the rear frame). The Y direction indicates the vertical direction of the liquid crystal panel (the upward direction which corresponds to the direction opposite to a second direction). The Z direction indicates the thickness direction of the liquid crystal panel (the direction from the front surface side toward the back surface which corresponds to a first direction).

The liquid crystal display 10 is one example of a display device and preferably includes a liquid crystal panel (not shown), a light source such as LEDs (not shown), a control circuit (not shown), a power supply circuit (not shown), a PCB 20, a COF 30, a substrate holding unit 40, a case that houses these members, and so forth.

The control circuit is a circuit that controls various circuits and mechanisms constituting the liquid crystal panel.

The power supply circuit is a circuit that converts AC power from an external power source into DC power to be used by a drive circuit and the liquid crystal panel and supplies the DC power to the drive circuit and the liquid crystal panel.

The PCB 20 is one example of a substrate and outputs signals from the control circuit (not shown) to an IC mounted on the COF 30. The PCB 20 is connected to the liquid crystal panel via the COF 30 (one example of the flexible cable).

The COF 30 is a flexible cable mounted with an IC. The COF 30 uses signals from the PCB 20 to generate signals that drive the liquid crystal panel and outputs the signals to the liquid crystal panel.

The substrate holding unit 40 holds the PCB 20. As shown in FIG. 2, in the state of holding the PCB 20, the substrate holding unit 40 is disposed in a position that is in the interior of the rear frame 11 shown in FIG. 1 and that is exposed to the outside when a cover 12 is removed.

The case of the liquid crystal display 10 includes a front cabinet (not shown), the rear frame 11, the cover 12 provided on the upper portion of the rear frame 11, and the like as shown in FIG. 1.

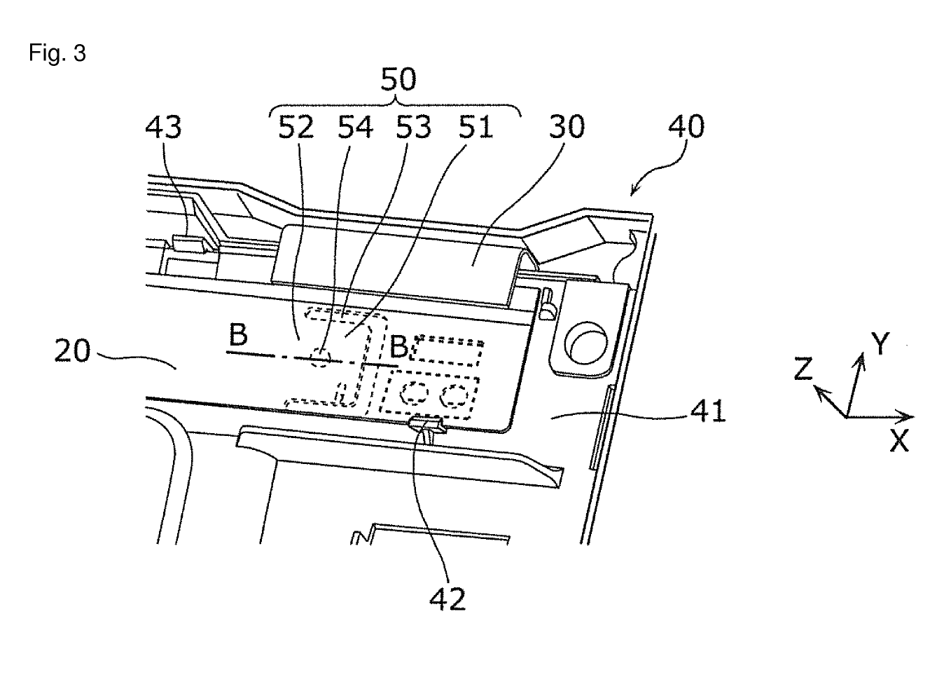

The configuration of the substrate holding unit 40 will be described based on FIGS. 3 to 5.

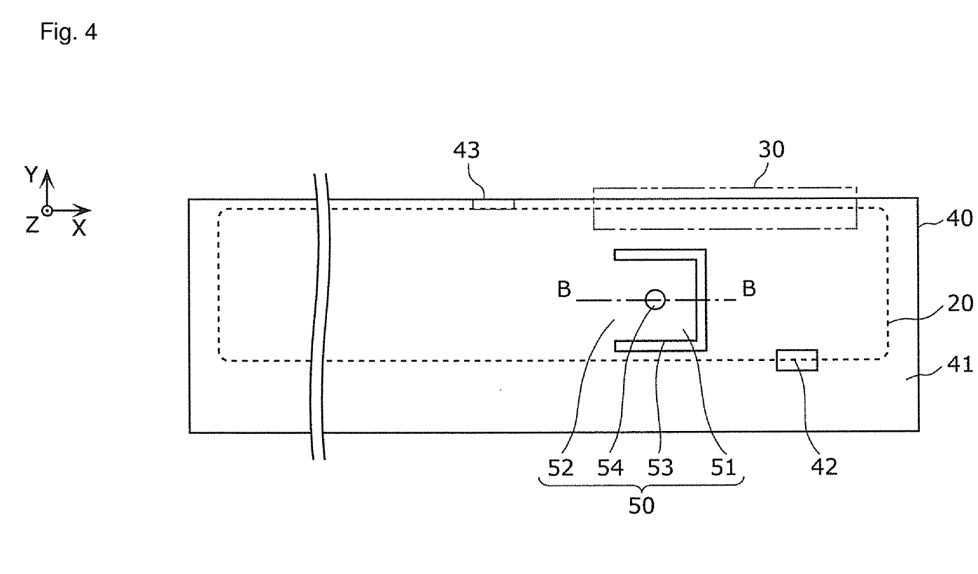

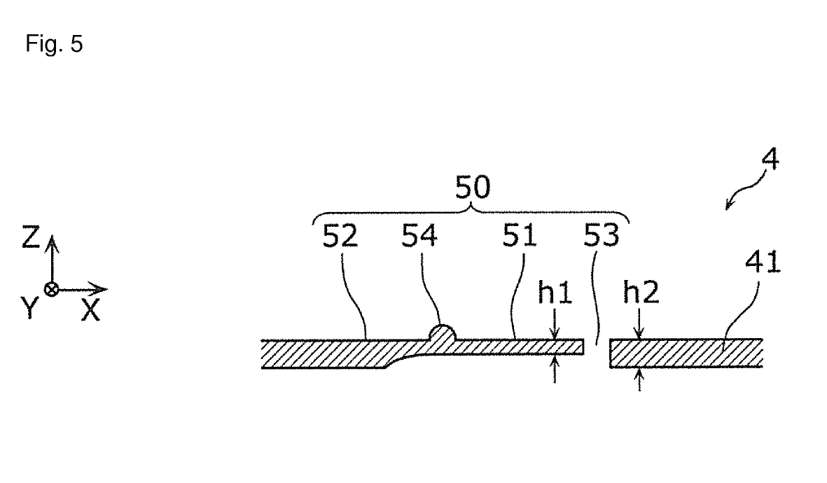

FIG. 3 is a partial perspective view showing one example of the configuration of the substrate holding unit 40 in a state in which the PCB 20 is attached. FIG. 4 is a model diagram of the substrate holding unit 40 as seen from the side to which the PCB 20 is attached. Note that the configurations other than that of the substrate holding unit 40 (PCB 20 and COF 30) are indicated by dotted lines in FIG. 4. FIG. 5 is a sectional view of the line B-B portion in FIGS. 3 and 4. Note that FIGS. 4 and 5 depict a leaf spring 50 of the substrate holding unit 40 shown in FIG. 3 in a simplified manner, and the dimensions and the like in the respective figures do not match in a strict sense.

As shown in FIGS. 3 to 5, the substrate holding unit 40 preferably includes a plate 41, clasps 42 and 43, and the leaf spring 50. Note that the substrate holding unit 40 also includes connections with the rear frame 11 or the like, though not depicted in FIG. 3.

The clasp 42 includes a second plate defining a second restricting member that extends in the Z direction from the surface of the plate 41 and a first plate defining a first restricting member that extends in a direction perpendicular or substantially perpendicular to the Z direction (in the Y direction in FIG. 3) from the tip end of the second restricting member. The first restricting member of the clasp 42 restricts the movement of the PCB 20 in the Z direction by the surface on the side of the plate 41 contacting the surface of the PCB 20. Moreover, the second restricting member of the clasp 42 restricts the movement of the PCB 20 in the direction opposite to the Y direction. In the present preferred embodiment, the clasp 42 preferably is integral with the plate 41.

The shape of the clasp 43 preferably is the same as that of the clasp 42. The clasp 43 defines a pair with the clasp 42 such that the second restricting member of the clasp 43 and the second restricting member of the clasp 42 sandwich the PCB 20 in the Y direction. In the present preferred embodiment, the clasp 43 preferably is integral with the plate 41.

The leaf spring 50 is configured as a portion of the plate 41.

In more specific terms, the leaf spring 50 includes a leaf spring main body 51, a support area 52, and an opening 53.

In order to hold the PCB 20, the leaf spring main body 51 includes, on the surface to which the PCB 20 is attached, a protrusion 54 that contacts the PCB 20 and presses the PCB 20 against the first restricting members of the clasps 42 and 43. In the present preferred embodiment, the protrusion 54 preferably has a hemispherical or substantially hemispherical shape as shown in FIGS. 3 to 5. In addition, the leaf spring main body 51 is configured such that a distance between the surface of the clasp 42 constituting the first restricting member and the portion of the protrusion 54 that contacts the PCB 20 preferably is shorter than the thickness of the PCB 20.

The leaf spring main body 51 is located in a rectangular or substantially area in the present preferred embodiment.

Furthermore, the thickness h1 of the leaf spring main body 51 is smaller than the thickness h2 of the plate 41 as shown in FIG. 5. Consequently, the leaf spring main body 51 is configured such that the end portion thereof on the opposite side of the support area 52 tends to swing in the direction opposite to the Z direction (and in the Z direction).

The support area 52 is located in one portion of the area surrounding the leaf spring main body 51 and functions such that the leaf spring main body 51 is supported on the substrate holding unit 40. In the present preferred embodiment, of the area surrounding the leaf spring main body 51, the support area 52 is located in an area that includes one long side of the leaf spring main body 51.

The opening 53 is preferably configured to be slit-shaped in an area of the plate 41 surrounding the leaf spring main body 51 excluding the support area 52. In the present preferred embodiment, the opening 53 preferably is located in an area of the plate 41 that surrounds the leaf spring main body 51 on the outside of three sides thereof excluding the long side which constitutes the support area. In other words, the opening 53 is configured so as to surround the leaf spring main body 51 in the three directions.

The substrate holding unit 40 according to a preferred embodiment of the present embodiment gently holds the PCB 20 with the leaf spring 50.

When the PCB 20 is held by the substrate holding unit 40, the protrusion 54 is pressed by the PCB 20 in the direction opposite to the Z direction, and the leaf spring main body 51 flexes in the direction opposite to the Z direction with the support area 52 as the fulcrum. The PCB 20 is pressed against the first restricting member of the clasp 42 as a result of the resilience of the leaf spring 50.

The substrate holding unit 40 of the present preferred embodiment gently holds the PCB 20 by utilizing the resilience of the leaf spring 50. Therefore, when a certain amount of force or more is applied in the Z direction and in the opposite direction thereof as a result of vibration of the liquid crystal display 10, the PCB 20 can move to some extent in the Z direction and in the opposite direction thereof. Consequently, it is possible to more favorably and reliably prevent the connecting portion between the COF 30 and the PCB 20 from being damaged or removed.

Moreover, because the protrusion 54 of the leaf spring 50 preferably has a hemispherical or substantially hemispherical shape in the present preferred embodiment, the protrusion 54 and the PCB 20 are in point contact with each other. The surface area of the contact surface between the protrusion 54 and the PCB 20 is significantly reduced in the present preferred embodiment. Consequently, even if the PCB 20 vibrates in the X direction and in the Y direction, because the contact surface between the substrate holding unit 40 and the PCB 20 is very small, the PCB 20 is held gently, thus making it possible to more favorably prevent the connecting portion between the COF 30 and the PCB 20 from being damaged or removed.

### Preferred Embodiment 2

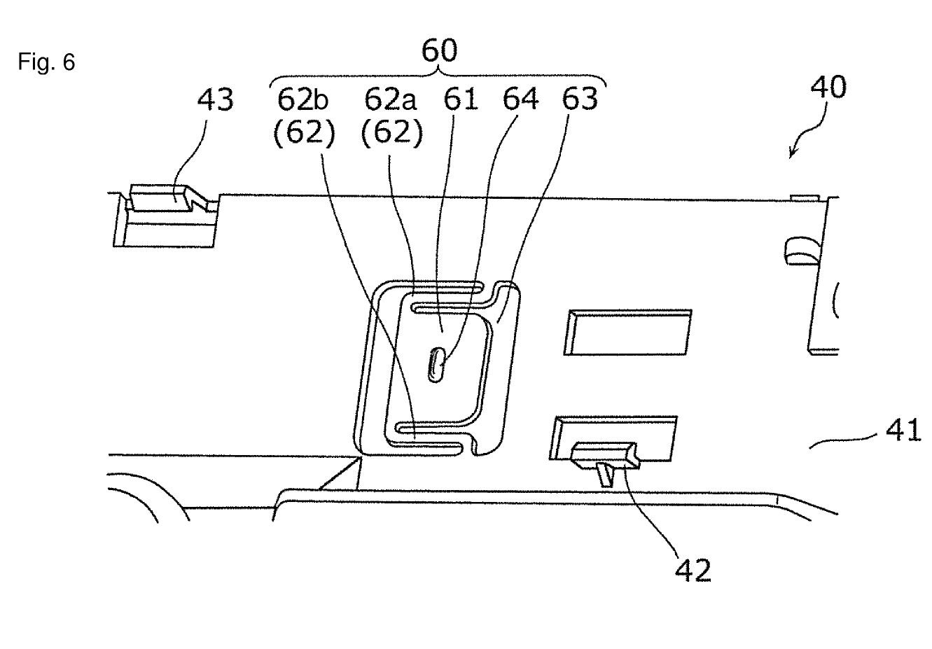

A display device according to Preferred Embodiment 2 will be described based on FIG. 6.

Note that in the present preferred embodiment, the case of the display device being a liquid crystal display will be described as an example as in Preferred Embodiment 1. In the present preferred embodiment, furthermore, the description will be based on a case in which the configuration of the leaf spring of the substrate holding unit 40 is different from that in Preferred Embodiment 1.

Note that the configuration of the liquid crystal display 10 is preferably the same or substantially the same as in Preferred Embodiment 1, except for the configuration of the leaf spring of the substrate holding unit 40.

The configuration of the substrate holding unit 40 of the present preferred embodiment will be briefly described. The substrate holding unit 40, just like Preferred Embodiment 1, preferably is configured to include a plate 41, clasps 42 and 43, and a leaf spring 60.

Note that the configuration of the clasps 42 and 43 is preferably the same or substantially the same as in Preferred Embodiment 1.

The leaf spring 60 is preferably defined by a portion of the plate 41 just as in Preferred Embodiment 1.

The leaf spring 60 preferably includes a leaf spring main body 61, a support area 62, and an opening 63.

In order to hold the PCB 20, the leaf spring main body 61 includes, on the surface to which the PCB 20 is attached, a protrusion 64 that contacts the PCB 20 and presses the PCB 20 against the first restricting members of the clasps 42 and 43. Note that this protrusion preferably has a conical or substantially conical shape as shown in FIG. 6. In addition, the leaf spring main body 61 is such that the distance between the surface of the clasp 42 that constitutes the first restricting member and the surface of the protrusion 64 that contacts the PCB 20 is preferably shorter than the thickness of the PCB 20.

The leaf spring main body 61 is preferably located in a rectangular or substantially rectangular area in the present preferred embodiment.

Moreover, although not shown in the figure, the thickness h1 of the leaf spring main body 61 is smaller than the thickness h2 of the plate 41 as in Preferred Embodiment 1. Consequently, the leaf spring main body 61 is configured such that the end portion thereof on the opposite side of the support area 62 tends to swing in the direction opposite to the Z direction (and in the Z direction).

The support area 62 is located in a portion of the area surrounding the leaf spring main body 61 and functions such that the leaf spring main body 61 is supported on the substrate holding unit 40. In the present preferred embodiment, the support area 62 preferably includes two rectangular or substantially rectangular regions 62a and 62b.

The region 62a is provided above the leaf spring main body 61 in the figure. The region 62a includes a slender rectangular or substantially rectangular first region, and a first connecting region that connects with the plate 41 is located above the tip end portion on the right side in the figure of this first region (e.g., one end of the long side). Furthermore, a second connecting region that connects with the leaf spring main body 61 is located below the tip end portion on the left side in the figure of the first region (e.g., the other end of the long side).

The region 62b is provided below the leaf spring main body 61 in the figure so as to define a pair with the region 62a. As with the region 62a, the region 62b includes a slender rectangular or substantially rectangular first region, and a first connecting region that connects with the plate 41 is located below the tip end portion on the right side in the figure of the first region (e.g., one end of the long side). Moreover, a second connecting region that connects with the leaf spring main body 61 is located above the tip end portion on the left side in the figure of the first region (e.g., the other end of the long side).

The opening 63 is provided in an area of the plate that surrounds the leaf spring main body 61 excluding the portions connected to the support area 62.

The substrate holding unit 40 of the present preferred embodiment gently holds the PCB 20 via the leaf spring 60.

When the PCB 20 is held by the substrate holding unit 40, the protrusion 64 is pressed by the PCB 20 in the direction opposite to the Z direction, and the leaf spring main body 61 flexes in the direction opposite to the Z direction with the first connecting regions that connect the regions 62a and 62b with the plate 41 as the fulcrum. The PCB 20 is pressed against the first restricting member of the clasp 42 by the resilience of the leaf spring 60.

The substrate holding unit 40 of the present preferred embodiment utilizes the resilience of the leaf spring 60 to gently hold the PCB 20. Therefore, when the liquid crystal display 10 vibrates and a certain amount of force or more is applied in the Z direction and in the opposite direction thereof, the PCB 20 can move to some extent in the Z direction and in the opposite direction thereof. This makes it possible to more favorably and reliably prevent the connecting portion between the COF 30 and the PCB 20 from being damaged or removed.

In addition, in the present preferred embodiment, because the protrusion 64 of the leaf spring 60 preferably has a conical or substantially conical shape, the protrusion 64 and the PCB 20 are almost in point contact with each other. That is, in the present preferred embodiment, as in Preferred Embodiment 1, the surface area of the contact surface between the protrusion 64 and the PCB 20 is significantly reduced. Consequently, even if the PCB 20 vibrates in the X direction and in the Y direction, because the contact surface between the substrate holding unit 40 and the PCB 20 is small, the PCB 20 is held gently, thus making it possible to more favorably and reliably prevent the connecting portion between the COF 30 and the PCB 20 from being damaged or removed.

### Other Preferred Embodiments

The display devices according to various preferred embodiments of the present invention were described above, but the present invention is in no way limited to the above-described embodiments.

For instance, the configuration of the leaf spring main body of the leaf spring preferably is rectangular or substantially rectangular in Preferred Embodiments 1 and 2, but the configuration is not limited to this.

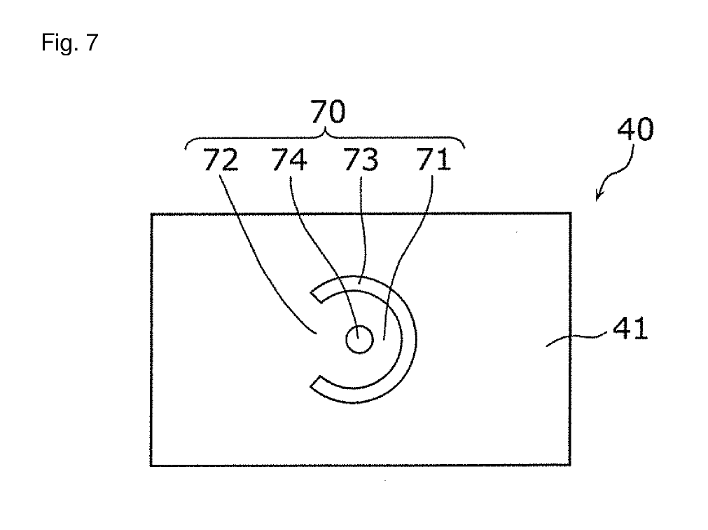

As shown in FIG. 7, the configuration of the leaf spring main body may also be circular or substantially circular, for example. The leaf spring 70 shown in FIG. 7 includes a circular or substantially circular leaf spring main body 71, a support area 72 located in a portion of the circular or substantially circular shape (approximately ¼ of the circumference), an opening 73 constituted by an arc-shaped slit (approximately ¾ of the circumference), and a hemispherical or substantially hemispherical protrusion 74.

The shape of the leaf spring main body may be polygonal or may also be a combined shape of a polygon, circle, and the like. Note that the shape of the opening does not need to be a slit shape. For example, when the shape of the leaf spring main body is circular or substantially circular (the internal shape of the opening is circular or substantially circular), the external shape of the opening may be rectangular or substantially rectangular, or the reverse thereof may be possible.

In Preferred Embodiments 1 and 2, cases were described in which a single leaf spring is provided on the substrate holding unit 40, but the present invention is not limited to this. A plurality of leaf springs may also be provided, depending on the size, shape, or the like of the PCB 20 defining the substrate.

In Preferred Embodiments 1 and 2, cases were described in which a single protrusion preferably is provided on a single leaf spring, but the present invention is not limited to this. A configuration is also possible in which a plurality of protrusions are provided on a single leaf spring, depending on the size, shape, or the like of the leaf spring main body.

In Preferred Embodiments 1 and 2, the substrate holding unit 40 preferably includes clasps 42 and 43 (first restricting members and second restricting members), but the present invention is not limited to this. For instance, it is also possible to have a configuration in which one of the clasps does not include a first restricting member.

Furthermore, in Preferred Embodiments 1 and 2, the first restricting members and the second restricting members preferably are integral with the plate, but the present invention is not limited to this.

Note that it is also possible to provide the substrate holding unit 40 with a third restricting member that restricts the movement of the PCB 20 in the X direction in Preferred Embodiments 1 and 2.

Moreover, various features, elements, arrangements, and configurations of the various preferred embodiments and the modified examples may also be individually combined.

For example, the configuration of the protrusion 54 of the leaf spring 50 in Preferred Embodiment 1 may also have a conical or substantially conical shape as in Preferred Embodiment 2. Alternatively, the configuration of the protrusion 64 of the leaf spring 60 in Preferred Embodiment 2 may also have a hemispherical or substantially hemispherical shape as in Preferred Embodiment 1. The configuration of the protrusion is arbitrary, and it is possible to use any shape that makes point contact with the PCB 20.

Preferred embodiments of the present invention are useful for liquid crystal displays or other such display devices including a substrate holding unit that holds a substrate.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A display device comprising:
a substrate holding unit configured to hold a substrate that is connected to a specified circuit using a cable, the substrate holding unit including:
a plate;
a first restricting member that restricts movement of the substrate in a first direction perpendicular or substantially perpendicular to a plane of the plate; and
a leaf spring provided in a portion of the plate; wherein
the leaf spring includes:
a leaf spring main body including, on a side of a surface on which the substrate is held, a protrusion that contacts the substrate and presses the substrate against the first restricting member to provide a holding force and which is configured to swing in the first direction; and
an opening provided in an area of the plate that surrounds the leaf spring main body excluding a support area which causes the leaf spring main body to be supported on the substrate holding unit.

2. The display device according to claim 1, wherein the protrusion is conical or substantially conical such that a sectional area of a cross section parallel or substantially parallel to the plane of the plate is smaller with increasing distance from the plane of the plate.

3. The display device according to claim 1, wherein the protrusion is hemispherical or substantially hemispherical.

4. The display device according to claim 1, wherein the protrusion is in point contact with the substrate.

5. The display device according to claim 1, wherein a thickness of the leaf spring main body is smaller than a thickness of a portion of the plate excluding the leaf spring main body.

6. The display device according to claim 1, wherein a second restricting member is further provided and configured to restrict the movement of the substrate in a second direction perpendicular or substantially perpendicular to the first direction.

7. The display device according to claim 6, wherein
the second restricting member includes a second plate that extends in the first direction from the surface of the plate; and
the first restricting member includes a first plate that extends in a direction perpendicular or substantially perpendicular to the first direction from a tip end of the second restricting member.

8. The display device according to claim 1, wherein the plate is made of resin.

9. The display device according to claim 1, wherein the opening surrounds the leaf spring main body in three directions.

10. The display device according to claim 1, wherein the support area includes:
a rectangular or substantially rectangular first region;
a first connecting region on a long side of the first region at one of tip end portions thereof and which connects with the plate; and
a second connecting region on a side facing a long side at another tip end portion of the first region and which connects with the leaf spring main body.
